(19) United States
(12) Patent Application Publication
(10) Pub. No.: US 2026/0209021 A1
(43) Pub. Date: Jul. 23, 2026

(54) CUSTOMIZED PERFUME-FILLING EQUIPMENT

(71) Applicants: GUANGDONG XUELEI FRAGRANCE INDUSTRIAL PARK CO., LTD., Guangzhou (CN); EVERFREE TECHNOLOGY (GUANGDONG) CO., LTD., Guangzhou (CN)

(72) Inventors: Zhenguo WENG, Guangzhou (CN); Haocong WENG, Guangzhou (CN)

(21) Appl. No.: 19/108,164

(22) PCT Filed: Nov. 1, 2023
(86) PCT No.: PCT/CN2023/128965

§ 371 Date: Mar. 2, 2025

(30) Foreign Application Priority Data
Sep. 18, 2023 (CN) 202311198288.3

(51) Int. Cl. B67C 7/00; B67B 3/10; B67C 3/20; B67C 3/24

(52) U.S. Cl. CPC B67C 7/004; B67B 3/10; B67C 3/208; B67C 3/24

(57) ABSTRACT

A customized perfume-filling equipment is provided, including a machine platform, a conveying track, a filling system, a mounting clamp, a bottle-in track, a bottle-out track, a bottle-grabbing manipulator, a central processor, and a controller. The filling system is configured to store a perfume and fill a bottle. The filling system is connected with pipelines configured for transporting perfume liquid, and the multiple pipelines are relatively independent of each other. The pipeline is provided therein with an electric control valve configured for controlling opening and closing of the pipeline. The central processor is configured to receive external user information and generate corresponding product formula information. The controller is electrically connected to the central processor and receives product formula information from the central processor. The controller is electrically connected to multiple electric control valves and is configured to control the opening and closing of the electric control valves.

### TECHNICAL FIELD

The present disclosure relates to the field of cosmetic production equipment, and particularly, to a customized perfume-filling equipment.

### BACKGROUND ART

Perfume is a liquid mixture of essential oils, fixatives, and alcohol or ethyl acetate that provides a long-lasting and pleasant smell. Essential oils are derived from flowers and plants and extracted by distillation methods or enfleurage methods. Scented organics can also be used. Fixatives are used to combine various fragrances. The concentration of alcohol or ethyl acetate depends on whether the product is perfume, eau de toilette, or cologne.

Among existing technical solutions, the utility model application with filling No. CN202222753549.0 discloses a perfume bottle filling mechanism, including a device body, in which a conveyor belt is arranged, with side frames arranged on both sides of the conveyor belt. Perfume tanks are arranged on both sides of the conveyor belt, and hydraulic cylinders are arranged on the perfume tanks. Two groups of the hydraulic cylinders are provided with connection plates at upper ends, with the connection plates located directly above the conveyor belt. Mounting holes are formed in the middle of the connection plates. Multiple liquid guide tubes are connected to the perfume tanks, and the other ends of the liquid guide tubes are provided with filling heads. The filling heads are fixed at lower ends of the mounting holes. A Placement box is placed on the conveyor belt, wherein a friction shaft is fixed in the placement box, and multiple groups of movable plates are arranged inside the placement box in a moving manner. Thus, synchronous filling operations and parallel transportation of multiple groups of perfume bottles can be realized, thereby improving the efficiency of filling perfume and saving time required for transportation.

However, as the self-awareness of consumers rises and their understanding of skincare improves, the desire for personalized skincare consumption is increasingly strong. Generic products are no longer sufficient to meet or cover the needs of personal preferences and skin characteristics of consumers. The aforementioned existing technology is also difficult to achieve personalized proportions based on the actual needs of consumers. Therefore, in the field of personalized perfume blending, at present, it is still necessary to manually arrange quantitative valves to carry out quantitative injection of various raw materials to achieve personalized customization, which is too inefficient.

### SUMMARY

The present disclosure aims to address at least one of the technical problems existing in the prior art. Thus, the present disclosure provides a customized perfume-filling equipment capable of automatically personalizing ingredient preparation based on actual demands during the production process, thereby improving overall work efficiency.

According to the embodiment of the first aspect of the present disclosure, the customized perfume-filling equipment includes a machine platform, a conveying track, a filling system, a mounting clamp, a bottle-in track, a bottle-out track, a bottle-grabbing manipulator, a central processor, and a controller. A surface of the machine platform is provided with a feeding station, multiple filling stations, a capping station, and a middle-ring pressing station. The conveying track is arranged in an annular shape above the machine platform. The conveying track is slidably connected with multiple sliding tables, and the sliding tables can move cyclically along the conveying track. The sliding tables move along a moving direction and sequentially pass through the feeding station, the multiple filling stations, the capping station, and the middle-ring pressing station. Multiple filling systems are provided, wherein the multiple filling systems are arranged along an extension direction of the conveying track and correspond one-to-one with the multiple filling stations. The filling system is configured to store a perfume and fill a bottle. The filling system is connected with pipelines configured for transporting perfume liquid, and the pipelines are relatively independent from each other. The pipelines are provided therein with electric control valves configured for controlling opening and closing of the pipeline, and the electric control valves are relatively independent from each other. The mounting clamp is configured to fix a body of a bottle and the mounting clamp is fixedly connected to the sliding table. The bottle-in track is arranged on a side of the machine platform. The bottle-out track is arranged on a side of the machine platform. The bottle-grabbing manipulator can move among the feeding station, the middle-ring pressing station, a discharge end of the bottle-in track, and a feeding end of the bottle-out track, and is configured to pick up the bottle. The central processor is configured to receive external user information and generate corresponding product formula information. The controller is electrically connected to the central processor and receives product formula information from the central processor. The controller is also electrically connected to multiple electric control valves and is configured to control the opening and closing of the electric control valves. The controller is electrically connected to the sliding table and is configured to control a movement distance of the sliding table.

The customized perfume-filling equipment according to the embodiments of the present disclosure provides at least the following advantageous effects. By utilizing the central processor, the controller, and multiple non-interfering filling systems in coordination, the equipment can perform automated personalized ingredient preparation based on actual requirements during the production process, thereby improving overall work efficiency.

According to some embodiments of the present disclosure, the equipment further includes a laser marking mechanism. The laser marking mechanism is arranged at the feeding station, and is capable of being provided corresponding to the mounting clamp, wherein the laser marking mechanism is electrically connected to the central processor, and receives the product formula information from the central processor.

According to some embodiments of the present disclosure, the equipment further includes a capping mechanism, a cap-grabbing manipulator, and a flexible cap placement tray. The capping mechanism is arranged at the capping station, and the capping mechanism is configured to cap the bottle located on the mounting clamp. The cap-grabbing manipulator is configured to place the flexible cap onto the top of the bottle.

According to some embodiments of the present disclosure, the capping mechanism includes a base, a pressing shaft, a rolling blade shaft, and a rolling blade, wherein the base is fixed on a surface of the machine platform. The pressing shaft is pivotally arranged on the base, the pressing shaft is capable of being raised and lowered along an axial direction of the pressing shaft on the base. A lower end of the pressing shaft is provided with an open pressing groove. The rolling blade shaft is mounted on the base and capable of being raised and lowered, and the rolling blade shaft is arranged parallel to the pressing shaft. One end of the rolling blade is provided with a blade edge, and the other end is rotatably connected to a lower end of the rolling blade shaft. When the rolling blade shaft is lowered, the blade edge swings toward an inner side of the pressing groove to press the flexible cap tightly. When the rolling blade shaft raises, the blade edge swings outward to disengage from the flexible cap.

According to some embodiments of the present disclosure, the capping mechanism further includes a sliding rod. One end of the sliding rod is slidably mounted on the base, and the other end is rotatably connected to the rolling blade. The connection position between the sliding rod and the rolling blade is located between the blade edge and the connection position between the rolling blade shaft and the rolling blade.

According to some embodiments of the present disclosure, on a section along the axial direction of the pressing shaft, an inner side surface of the pressing groove is inclined toward the outside from top to bottom.

According to some embodiments of the present disclosure, the filling system includes a raw liquid supply portion, a liquid mixing portion, and a mixed liquid supply portion. The raw liquid supply portion is configured to provide liquids for mixing. The liquid mixing portion includes a dilution component, a pressure-stabilizing valve body, and a flow meter. The dilution component is connected to the raw liquid supply portion and is configured to receive the liquid from the raw liquid supply portion and mix it to obtain a mixed liquid. The pressure-stabilizing valve body and the flow meter are arranged on a pipeline connecting the raw liquid supply portion to the dilution component. The pressure-stabilizing valve body is configured to control a flow rate of the liquid passing through the flow meter, and the flow meter is configured to measure a flow rate of a liquid passing through the pipeline. The mixed liquid supply portion includes a first pump and a supply component. The first pump is connected to the dilution component and the raw liquid supply portion and is configured to transport the liquid from the raw liquid supply portion to the dilution component. The supply component is connected to the dilution component and is configured to receive and store the mixed liquid from the dilution component. The supply component contains a second pump and is connected to the pipeline, and the mixed liquid in the supply component is supplied into the pipeline through the second pump.

According to some embodiments of the present disclosure, the filling system further includes a control component, wherein the control component is electrically connected to the central processor and is configured to receive the product formula information from the central processor. The control component is electrically connected to the mixed liquid supply portion and presets and controls the flow rate and a discharge time of a liquid in the mixed liquid supply portion based on the product formula information from the central processor.

According to some embodiments of the present disclosure, the equipment further includes a middle-ring pressing mechanism, a middle-ring grabbing manipulator, and a middle-ring placement tray. The middle-ring pressing mechanism is arranged at the middle-ring pressing station, and the middle-ring pressing mechanism is configured to press the middle ring onto the bottle located on the mounting clamp. The middle-ring grabbing manipulator is configured to place the middle ring onto the bottle.

According to some embodiments of the present disclosure, the middle-ring pressing mechanism includes a frame, a clamping block, a pressing rotating wheel, and a clamping sleeve. The frame is fixedly mounted on the machine platform. The clamping block is mounted on the frame in a horizontally movable manner, and the clamping block is provided with a clamping groove. The pressing rotating wheel is pivotally mounted on the machine platform, and the pressing rotating wheel movable along a horizontal plane on the machine platform, reciprocating relative to the clamping block, to cooperate with the clamping block to form a pressing region. The clamping sleeve is positioned above the pressing region, and the clamping sleeve is mounted on the frame in a liftable manner. The clamping sleeve is configured to be sleeved over the top of the bottle, wherein the clamping block is connected to a first cylinder, wherein the first cylinder is configured to drive the clamping block to reciprocate relative to the pressing rotating wheel. A slider is arranged on the frame, and the pressing rotating wheel is mounted on the upper surface of the slider in a pivotable manner. The slider is connected to a second cylinder, and the second cylinder is configured to drive the slider to reciprocate relative to the clamping block. The clamping sleeve is connected to a third cylinder, and the third cylinder is configured to drive the clamping sleeve up and down. The first cylinder, the second cylinder, and the third cylinder are all fixedly connected to the frame.

The technical effects are as follows. By utilizing the central processor, the controller, and multiple non-interfering filling systems in coordination, personalized ingredient preparation can be performed automatically based on actual requirements during the production process, thereby improving overall work efficiency. Additionally, the use of the sliding conveying track in conjunction with the filling system, the capping mechanism, and the middle-ring pressing mechanism enables full automation of the filling process.

Additional aspects and advantages of the present disclosure will be provided in part in the following description, and in part will become apparent from the following description, or will be learned through practice of the present disclosure.

### BRIEF DESCRIPTION OF DRAWINGS

The present disclosure will be further described in detail below in conjunction with the drawings and embodiments.

FIG. 1 is a perspective schematic diagram of a customized perfume-filling equipment according to the embodiment of the present disclosure;

FIG. 2 is a top-view schematic diagram of a customized perfume-filling equipment according to the embodiment of the present disclosure;

FIG. 3 is an enlarged schematic diagram of portion A in FIG. 1;

FIG. 4 is a schematic diagram of a filling system of a customized perfume-filling equipment according to the embodiment of the present disclosure;

FIG. 5 is a schematic diagram showing an electrical connection of a central processor, a controller, electric control valves, and a sliding table in a customized perfume-filling equipment according to the embodiment of the present disclosure;

FIG. 6 is a schematic diagram of a capping mechanism of a customized perfume-filling equipment according to the embodiment of the present disclosure; and

FIG. 7 is a schematic diagram of a middle-ring pressing mechanism of a customized perfume-filling equipment according to the embodiment of the present disclosure.

100—machine platform; 110—feeding station; 120—filling station; 130—capping station; 140—middle-ring pressing station; 150—bottle-in track; 160—bottle-out track; 170—bottle-grabbing manipulator;
200—conveying track; 210—sliding table;
300—filling system; 310—raw liquid supply portion; 320—liquid mixing portion; 321—dilution component; 322—pressure-stabilizing valve body; 323—flow meter; 330—mixed liquid supply portion; 331—first pump; 332—supply component; 3321—second pump; 340—control component; 301—pipeline; 3011—electric control valve;
400—mounting clamp;
500—central processor;
600—controller;
700—laser marking mechanism;
800—capping mechanism; 810—base; 820—pressing shaft; 821—pressing groove; 830—rolling blade shaft; 840—rolling blade; 841—blade edge; 850—sliding rod; 801—cap-grabbing manipulator; 802—flexible cap placement tray; 8021—flexible cap conveying track;
900—middle-ring pressing mechanism; 910—frame; 911—slider; 920—clamping block; 921—clamping groove; 922—first cylinder; 930—pressing rotating wheel; 931—second cylinder; 940—clamping sleeve; 941—third cylinder; 901—middle-ring placement tray; 9011—middle ring conveying track;
1-bottle.

### DETAILED DESCRIPTION OF EMBODIMENTS

The following describes the embodiments of the present disclosure in detail. Examples of the embodiments are illustrated in the drawings, where the same or similar reference numerals throughout indicate the same or similar elements or elements having the same or similar functions. The embodiments described below by reference to the drawings are exemplary and are intended only to explain the present disclosure and are not to be construed as a limitation of the present disclosure.

In the description of the present disclosure, it should be understood that the directions or positional relationships indicated by the directions, such as up, down, front, back, left, right, etc., are based on the directions or positional relationships shown in the drawings. These terms are used for the purpose of describing the present disclosure and simplifying the description, and they do not imply or suggest that the device or components being referred to must have specific orientations or be constructed and operated in a particular way. Therefore, these terms should not be construed as limitations on the scope of protection for the present disclosure.

In the description of the present disclosure, the meaning of “multiple” is one or more, the meaning of “more” is more than two, “greater than”, “less than”, “exceed”, etc. are understood as not including the number itself, and “above”, “below”, “within”, etc. are understood as including the number itself. If there is a description of the first and the second, it is only used for the purpose of distinguishing the technical features, and it cannot be understood as indicating or implying the relative importance or implicitly indicating the number of the indicated technical features or implicitly indicating the order of the indicated technical features.

In the description of the present disclosure, unless otherwise clearly defined, the terms such as “arrange”, “mount”, “connect”, etc. should be understood in a broad sense, and those skilled in the field can reasonably determine the specific meaning of the above terms in the present disclosure in combination with the specific content of the technical solution.

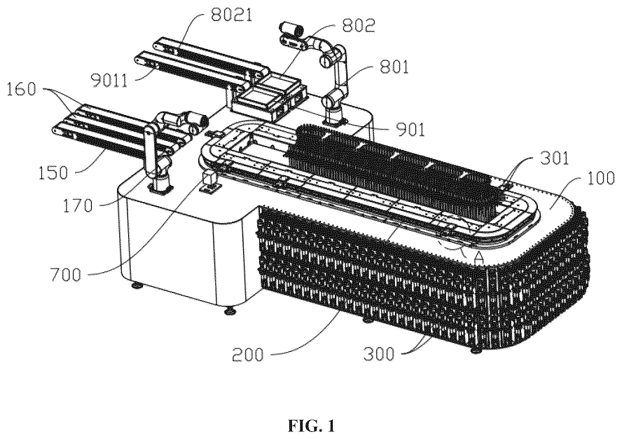

Referring to FIGS. 1 to 7, a customized perfume-filling equipment is provided in the embodiments of the present disclosure, including a machine platform 100, a conveying track 200, a filling system 300, a mounting clamp 400, a bottle-in track 150, a bottle-out track 160, a bottle-grabbing manipulator 170, a central processor 500, and a controller 600. A surface of the machine platform 100 is provided with a feeding station 110, multiple filling stations 120, a capping station 130, and a middle-ring pressing station 140. The conveying track 200 is arranged in an annular shape above the machine platform 100. The conveying track 200 is slidably connected with multiple sliding tables 210, and the sliding tables 210 can move cyclically along the conveying track 200. The sliding tables 210 move in a moving direction and sequentially pass through the feeding station 110, multiple filling stations 120, the capping station 130, and the middle-ring pressing station 140. Multiple filling systems 300 are provided, with the multiple filling systems 300 arranged along an extension direction of the conveying track 200 and corresponding one-to-one with the multiple filling stations 120. The filling system 300 is configured to store perfume and fill the bottle 1. The filling system 300 is connected with pipeline 301 configured for transporting perfume liquid, and the multiple pipelines 301 are relatively independent of each other. The pipeline 301 is provided therein with an electric control valve 3011 configured for controlling an opening and closing of the pipeline 301, and multiple electric control valves 3011 are relatively independent of each other. The mounting clamp 400 is configured to fix a body of the bottle 1 and the mounting clamp 400 is fixedly connected to the sliding table 210. The bottle-in track 150 is arranged on a side of the machine platform 100. The bottle-out track 160 is arranged on a side of the machine platform 100. The bottle-grabbing manipulator 170 can move among the feeding station 110, the middle-ring pressing station 140, a discharge end of the bottle-in track 150, and a feeding end of the bottle-out track 160, and is configured to pick up the bottle 1. The central processor 500 is configured to receive external user information and generate corresponding product formula information. The controller 600 is electrically connected to the central processor 500 and receives product formula information from the central processor 500. The controller 600 is also electrically connected to multiple electric control valves 3011 and is configured to control the opening and closing of the electric control valves 3011. The controller 600 is electrically connected to the sliding table 210 and is configured to control a movement distance of the sliding table 210.

In actual use, the steps include the following.
Step 1: as the sliding table 210 moves along the conveying track 200, the mounting clamp 400 is transported to the feeding station 110.
Step 2: the bottle-grabbing manipulator 170 transfers the empty bottle 1 placed on the bottle-in track 150 to the mounting clamp 400; and the mounting clamp 400 constrains the position of the bottle 1, so that the bottle 1 can only be fixed to the mounting clamp 400 and move along with the mounting clamp 400.
Step 3: the sliding table 210 continues moving along the conveying track 200, to make the bottle 1 move along with the mounting clamp 400 to the filling station 120.
Step 4: after the mounting clamp 400 transports the bottle 1 to the filling station 120, the filling system 300 is activated, injecting the corresponding raw materials for perfume mixing into the bottle 1 to prepare the perfume.
Step 5: once the perfume mixing preparation is completed, the bottle 1, driven by the sliding table 210, moves to a position near the capping station 130 where the cap body is placed on the end of the bottle 1.
Step 6: the bottle 1, along with the mounting clamp 400, moves to the capping station 130, and the capping mechanism 800 is used to cap the bottle 1.
Step 7: after capping, the bottle 1, driven by the sliding table 210, moves to a position near the middle-ring pressing station 140 where the middle ring is sleeved on the end of the bottle 1.
Step 8: the bottle 1, along with the mounting clamp 400, moves to the middle-ring pressing station 140; and the middle-ring pressing mechanism 900 is used to press the middle ring onto the bottle 1, tightening the middle ring.
Step 9: the bottle 1 is taken out from the mounting clamp 400 by the bottle-grabbing manipulator 170, and is placed in the bottle-out track 160 for discharging.

Among the steps, the following points need to be emphasized.

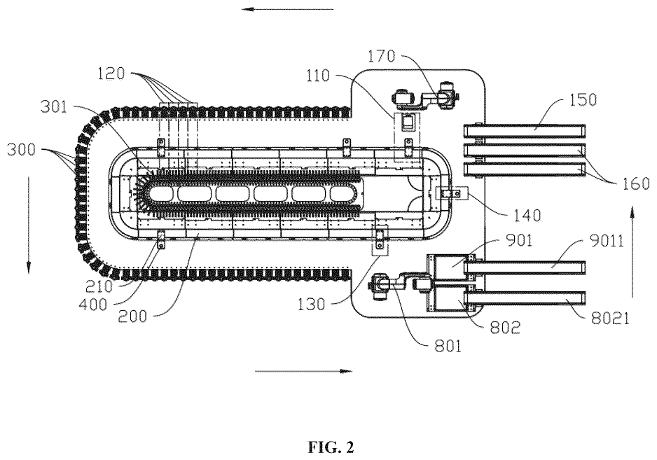

Firstly, in step 1 to step 9, the sliding table 210 moves cyclically on the annular conveying track 200 (moving in the directions of the four arrows shown in FIG. 2). Therefore, the number of mounting clamps 400 is fixed and the mounting clamps 400 can be reused. Specifically, the bottle-grabbing manipulator 170 is utilized for loading and unloading to ensure that each bottle 1 entering the feeding station 110 is empty.

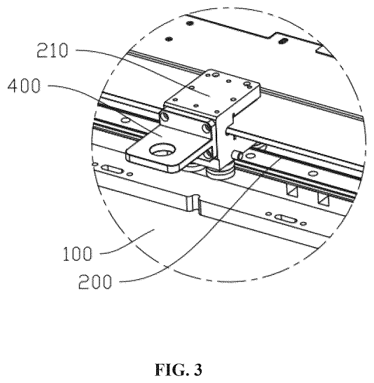

Secondly, referring to FIG. 3, the mounting clamp 400 can be a placement plate fixed on the sliding table 210. The placement plate is provided with a positioning hole configured to constrain the position of the bottle 1. By matching the positioning hole with the upper surface of the placement plate, the bottle 1 can be directly inserted into the positioning hole, thereby securing the position of the bottle 1. Since the shapes of different perfume bottles 1 vary, the mounting clamp 400 needs to be further designed according to the actual shape of the bottle 1. The design of the mounting clamp 400 belongs to routine technical methods known to those skilled in the art and will not be detailed here.

Thirdly, in Step 4, the raw perfume materials placed in the multiple filling systems 300 are not identical. Based on the perfume recipe, different raw perfume materials are allocated in different filling systems 300. The specific working process of the step 4 is as follows.

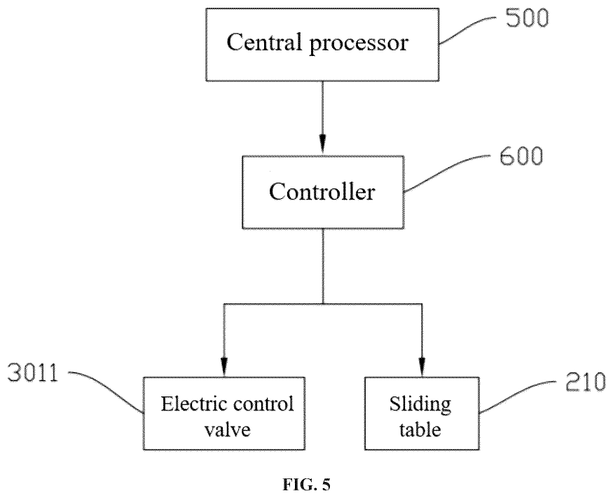

Referring to FIG. 5, the manufacturer inputs specific product formula requirements (external user information) into the central processor 500 based on consumer order requirements. The central processor 500 generates the corresponding product formula information, and data communication is achieved by electrical connection to transmit the product formula information to the controller 600 via. The controller 600 controls the corresponding electronic control valves 3011 based on the detailed data in the product formula information to open corresponding electronic control valves 3011, so that the corresponding pipelines 301 are opened. Simultaneously, the controller 600 drives the sliding table 210 to move to the corresponding pipeline 301 based on the detailed data in the product formula information and uses the corresponding filling system 300 to inject the perfume raw materials into the bottle 1.

Fourthly, in Step 9, two bottle-out tracks 160 are provided. Finished and defective products can be distinguished through manual identification or visual recognition, and are then placed on different bottle-out tracks 160 for transportation, respectively.

In summary, by utilizing the central processor 500, the controller 600, and multiple non-interfering filling systems 300 in coordination, the equipment can perform automated personalized ingredient preparation based on actual requirements during the production process, thereby improving overall work efficiency.

As can be seen from step 5 and step 6 above, the customized perfume-filling equipment of the present disclosure further includes a capping mechanism 800. Referring to FIG. 2, a corresponding cap-grabbing manipulator 801 and a flexible cap placement tray 802 are also provided on the machine platform 100. The flexible cap placement tray 802 is correspondingly arranged with a flexible cap conveying track 8021. The capping mechanism 800 is arranged at the capping station 130, and the capping mechanism 800 is configured to cap the bottle 1 located on the mounting clamp 400. The cap-grabbing manipulator 801 is configured to place the flexible cap onto the top of the bottle 1.

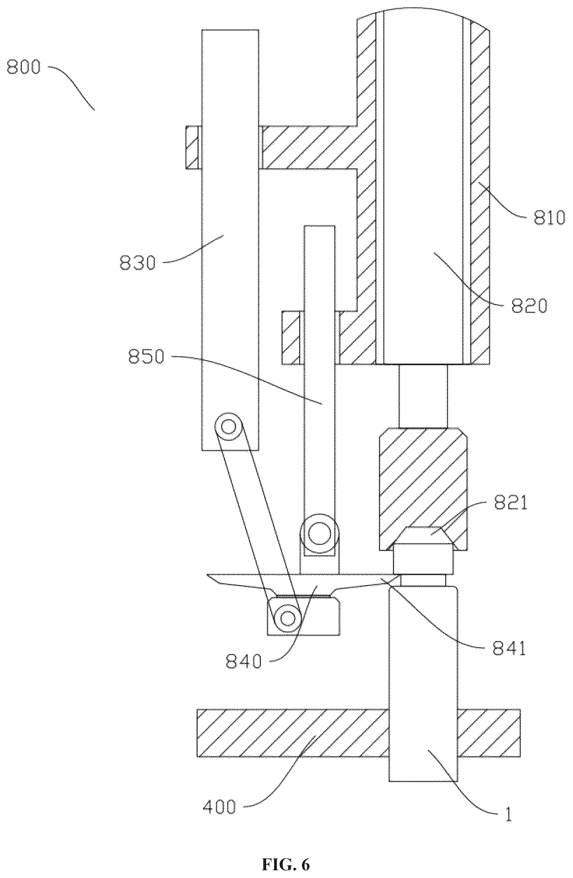

Specifically, referring to FIG. 6, the capping mechanism 800 includes a base 810, a pressing shaft 820, a rolling blade shaft 830, and a rolling blade 840. The base 810 is fixed to the surface of the machine platform 100. The pressing shaft 820 is arranged on the base 810 in a pivotable manner, and the pressing shaft 820 can be raised and lowered along an axial direction of the pressing shaft 820 on the base 810. A lower end of the pressing shaft 820 is provided with an opened pressing groove 821. The rolling blade shaft 830 is mounted on the base 810 in a manner that allows it to be raised and lowered, and the rolling blade shaft 830 is arranged parallel to the pressing shaft 820. One end of the rolling blade 840 is provided with a blade edge 841, and the other end is rotatably connected to a lower end of the rolling blade shaft 830. When the rolling blade 830 shaft is lowered, the blade edge 841 swings toward an inner side of the pressing groove 821 to tighten the flexible cap. When the rolling blade shaft 830 raises, the blade edge 841 swings outward to disengage from the flexible cap.

The capping mechanism 800, in practical use, enables the mounting clamp 400 loaded with the bottle 1, during the movement of the sliding table 210 along the conveying track 200, to move into the base 810, specifically under the pressing shaft 820. At this time, the pressing shaft 820 is driven to move downward, so that the pressing groove 821 of the pressing shaft 820 is pressed on the cap at the end of the bottle 1, ensuring that the flexible cap is sleeved on the end of the bottle 1. Then, the rolling blade shaft 830 is driven to be lowered, causing the rolling blade 840 located beneath the flexible cap to swing. Specifically, one end of the blade edge 841 swings inward and upward, abutting against the flexible cap and pressing the lower end of the flexible cap tightly. After tightly pressing at one position, the pressing shaft 820 is driven to pivot, causing a relative rotation between the base 810 and the pressing shaft 820. This allows the rolling blade 840 to rotate around the flexible cap for one or more circles, thereby tightly pressing the flexible cap.

Herein, the bottle 1 can rotate relative to the mounting clamp 400. After the bottle 1 is arranged in the mounting clamp 400, the bottle 1 can only pivot within the mounting clamp 400. During the above working process, the friction between the pressing groove 821 and the flexible cap drives the flexible cap to rotate, enabling the rolling blade 840 to tightly press the entire lower end of the flexible cap.

Further, referring to FIG. 6, the capping mechanism 800 further includes a sliding rod 850. One end of the sliding rod 850 is slidably mounted on the base 810, and the other end is rotatably connected to the rolling blade 840. The connection position between the sliding rod 850 and the rolling blade 840 is located between the blade edge 841 and the connection position between the rolling blade shaft 830 and the rolling blade 840. The rolling blade 840, the rolling blade shaft 830, and the sliding rod 850 form a lever principle. When the rolling blade shaft 830 moves downward, the end of the sliding rod 850 serves as a fulcrum, causing the blade edge 841 of the rolling blade 840 to lift upward and perform capping on the flexible cap. On the other hand, when the sliding rod 850 move upward or downward synchronously with the rolling blade shaft 830, the position of the rolling blade 840 can be adjusted to adapt to bottles 1 of different heights and perform capping on bottles 1 of varying heights.

To further tightly press the flexible cap, on a section along an axial direction of the pressing shaft 820, an inner side surface of the pressing groove 821 is inclined toward the outside from top to bottom.

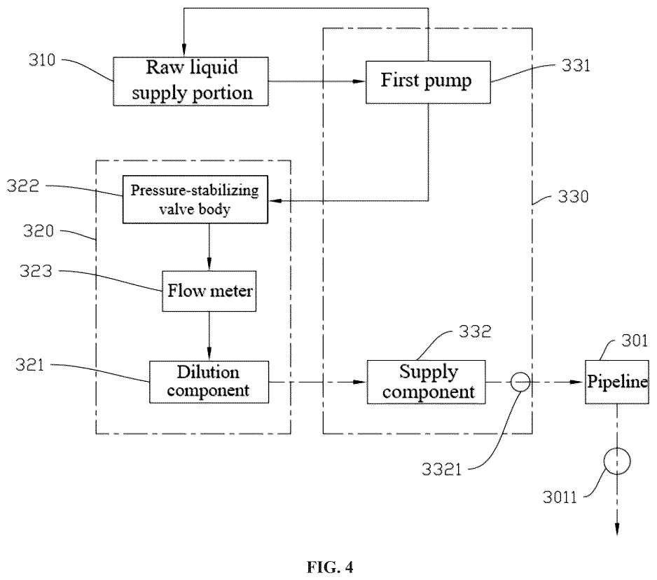

In some embodiments, referring to FIG. 4, the filling system 300 includes a raw liquid supply portion 310, a liquid mixing portion 320, and a mixed liquid supply portion 330. The raw liquid supply portion 310 is configured to provide liquids for mixing. The liquid mixing portion 320 includes a dilution component 321, a pressure-stabilizing valve body 322, and a flow meter 323. The dilution component 321 is connected to the raw liquid supply portion 310 and is configured to receive the liquid from the raw liquid supply portion 310 and mix it to obtain a mixed liquid. The pressure-stabilizing valve body 322 and the flow meter 323 are arranged on a pipeline connecting the raw liquid supply portion 310 to the dilution component 321. The pressure-stabilizing valve body 322 is configured to control a flow rate of the liquid passing through the flow meter 323, and the flow meter 323 is configured to measure the flow rate of the liquid passing through the pipeline. The mixed liquid supply portion 330 includes a first pump 31 and a supply component 332. The first pump 31 is connected to the dilution component 321 and the raw liquid supply portion 310, and is configured to transport the liquid from the raw liquid supply portion 310 to the dilution component 321. The supply component 332 is connected to the dilution component 321 and is configured to receive and store the mixed liquid from the dilution component 321. The supply component 332 contains a second pump 3321, and is connected to the pipeline 301 to supply the mixed liquid in the supply component 332 to the pipeline 301 through the second pump 3321.

Specifically, the pressure-stabilizing valve body 322 and the flow meter 323 are configured for mixing and proportioning the perfume raw materials, and can achieve high-precision matching of the concentration of the output perfume raw materials (by using the pressure-stabilizing valve body 322 to control flow rate and the flow meter 323 to detect specific liquid flow in real-time), thereby improving the customization range for personalized customization. Furthermore, the automated transport and circulation of the filling system 300 significantly enhance the efficiency of liquid supply. The raw liquid supply portion 310 can be a container for storing liquid, which can include at least one storage container for one or more types of liquids. Specifically, it can be a first container configured to hold a specific perfume raw material and a second container for pure water configured to dilute the concentration of the perfume raw material. In the above-mentioned dilution component 321, the dilution component 321 is connected to the raw liquid supply portion 310 via pipelines, with the pressure-stabilizing valve body 322 and the flow meter 323 arranged on the pipelines. As another embodiment, the flow meter 323 can be arranged between the pressure-stabilizing valve body 322 and the dilution component 321. Moreover, in the embodiment where the liquid flows through the flow meter 323 after passing through the pressure-stabilizing valve body 322, the liquid is stabilized as it passes through the flow meter 323, thereby improving measurement accuracy. According to the Bernoulli principle, the pressure of the liquid flow is proportional to the square of the liquid velocity, and the liquid flow rate is proportional to the liquid velocity. Therefore, the pressure-stabilizing valve body 322 stabilizes the pressure of the liquid passing through the pressure-stabilizing valve body 322, and in fact, it has the technical effect of controlling the flow of liquid passing through the flow meter 323. Thereby, the pressure-stabilizing valve body 322 adjusts the liquid flow rate, and the flow meter 323 observes the liquid flow rate.

Further, referring to FIG. 4 and FIG. 5, The filling system 300 further includes a control component 340, wherein the control component 340 is electrically connected to the central processor 500 and is configured to receive product formula information from the central processor 500. The control component 340 is electrically connected to the mixed liquid supply portion 330, and presets and controls the flow rate and discharge time of the liquid in the mixed liquid supply portion 330 based on the product formula information from the central processor 500.

It should be noted that the flow rate data measured by the flow meter 323 can be fed back to the control part. The control part calculates the volume or mass of the liquid that has passed through the flow meter 323 based on the flow rate data, thereby determining whether the volume or mass of liquid delivered by a specific raw liquid supply portion 310 to the liquid mixing portion 320 meets the expected ratio value. To avoid measurement errors of the flow meter 323, i.e., calculation errors during dispensing, the control part calculates, based on the dilution ratio of the mixed liquid, the mass or volume of one or more liquids before each raw liquid supply portion 310 delivers liquid. Using the liquid pressure set by the pressure-stabilizing valve body 322 and the Bernoulli principle, the flow rate and velocity of the liquid are calculated to determine the dispensing time for one or more liquids. Based on the calculated dispensing time, the upper and/or lower time limit for the dispensing of one or more liquids is set. The embodiment monitors the upper limit and/or the lower limit of the actual dispensing time through the flow meter 323 using the theoretically calculated dispensing time, thereby avoiding liquid ratio errors caused by the measurement errors of the flow meter 323.

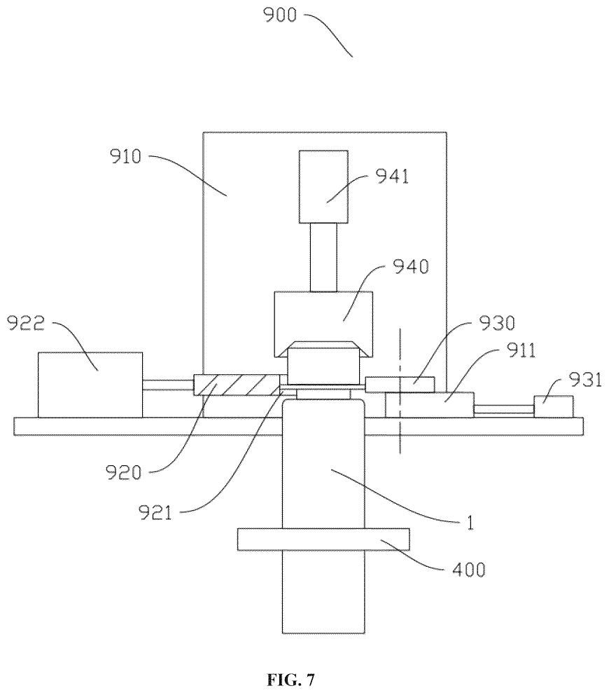

From the above-described step 7 and step 8, it can be seen that in some embodiments, and with reference to FIG. 1 and FIG. 7, the customized perfume-filling equipment of the present disclosure further includes a middle-ring pressing mechanism 900, wherein a corresponding middle-ring grabbing manipulator and a middle-ring placement tray 901 are also arranged on the machine platform 100. Specifically, the middle-ring grabbing manipulator can be the same manipulator as the aforementioned cap-grabbing manipulator 801. By expanding the activity region of the manipulator, a single manipulator can perform both cap-grabbing and middle-ring-fetching operations. The middle-ring placement tray 901 can be correspondingly provided with a middle ring conveying track 9011. Preferably, the middle-ring pressing mechanism 900 is arranged at the middle-ring pressing station 140, and the middle-ring pressing mechanism 900 is configured to press a middle ring on the bottle 1 located on the mounting clamp 400. The middle-ring grabbing manipulator is configured to arrange the middle ring onto the bottle 1. The middle-ring pressing mechanism 900 is used to press the middle ring, which is sleeved on the upper end of the bottle 1, to match the shape of the bottle 1.

Further, referring to FIG. 7, the above-mentioned middle-ring pressing mechanism 900 includes a frame 910, a clamping block 920, a pressing rotating wheel 930, and a clamping sleeve 940. The frame 910 is fixedly mounted on the machine platform 100. The clamping block 920 is mounted on the frame 910 in a horizontally movable manner, and the clamping block 920 is provided with a clamping groove 921. The pressing rotating wheel 930 is mounted on the machine platform 100 in a pivotable manner, and the pressing rotating wheel 930 is movable along a horizontal plane on the machine platform 100, reciprocating relative to the clamping block 920, to cooperate with the clamping block 920 to form a pressing region. The clamping sleeve 940 is positioned above the pressing region, and the clamping sleeve 940 is mounted on the frame 910 in a liftable manner. The clamping sleeve 940 is configured to be sleeved over the top of the bottle 1. The clamping block 920 is connected to a first cylinder 922, wherein the first cylinder 922 is configured to drive the clamping block 920 to reciprocate relative to the pressing rotating wheel 930. A slider 911 is arranged on the frame 910, and the pressing rotating wheel 930 is mounted on the upper surface of the slider 911 in a pivotable manner. The slider 911 is connected to a second cylinder 931, and the second cylinder 931 is configured to drive the slider 911 to reciprocate relative to the clamping block 920. The clamping sleeve 940 is connected to a third cylinder 941, and the third cylinder 941 is configured to drive the clamping sleeve 940 up and down. The first cylinder 922, the second cylinder 931, and the third cylinder 941 are all fixedly connected to the frame 910.

In actual use, when the mounting clamp 400 carrying the bottle 1 moves into the frame 910 and positions the bottle 1 within the pressing region, the third cylinder 941 is activated, causing the clamping sleeve 940 to be sleeved onto the upper end of the bottle 1. This constrains the position of the bottle 1 and prevents the bottle 1 from shaking. Subsequently, the first cylinder 922 and the second cylinder 931 respectively drive the clamping block 920 and the slider 911 to move relative to each other, aligning the clamping groove 921 of the clamping block 920 with the bottle 1, such that the bottle 1 is embedded into the clamping groove 921. Simultaneously, the pressing rotating wheel 930, which is rotatably connected to the slider 911, abuts against the surface of the bottle 1. Specifically, the middle ring abuts against both the clamping groove 921 and the pressing rotating wheel 930 at the same time. Using pressure, the middle ring is tightened onto the surface of the bottle 1. After pressing at a point, the pressing rotating wheel 930 rotates, causing the bottle 1 to rotate along with the rotation of the pressing rotating wheel 930. This achieves a 360° tightening of the middle ring onto the bottle 1. After pressing is complete, the first cylinder 922 and the second cylinder 931 are used to separate the clamping block 920 and the pressing rotating wheel 930 from each other, preventing positional interference between the mounting clamp 400 and the middle-ring pressing mechanism 900 when the bottle 1 moves along with the mounting clamp 400.

With reference to FIG. 1 and FIG. 2, the customized perfume-filling equipment of the present disclosure further includes a laser marking mechanism 700. The laser marking mechanism 700 is arranged at the feeding station 110 and corresponds to the mounting clamp 400. The laser marking mechanism 700 is electrically connected to the central processor 500 and receives the product formula information from the central processor 500. The laser marking mechanism 700 is used to directly print product information onto the bottle body, further optimizing the workflow of the entire filling process and enhancing automation.

The above description of the embodiments of the present disclosure has been provided in conjunction with the drawings. However, the present disclosure is not limited to the embodiments described above. Various modifications may be made within the scope of knowledge possessed by those of ordinary skill in the art without departing from the spirit of the present disclosure.

What is claimed is:

1. A customized perfume-filling equipment, comprising a machine platform, a conveying track, a filling system, a mounting clamp, a bottle-in track a bottle-out track, a bottle-grabbing manipulator, a central processor and a controller,
wherein a surface of the machine platform is provided with a feeding station multiple filling stations, a capping station, and a middle-ring pressing station;
the conveying track is arranged in an annular shape above the machine platform the conveying track is slidably connected with multiple sliding tables;
the sliding tables are capable of moving cyclically along the conveying track, wherein the sliding tables move along a moving direction and sequentially pass through the feeding station the multiple filling stations the capping station, and the middle-ring pressing station;
multiple filling systems are provided, wherein the multiple filling systems are arranged along an extension direction of the conveying track and correspond one-to-one with the multiple filling stations; the filling system is configured to store perfume and fill bottle; the filling system is connected with pipelines configured for transporting perfume liquid, and the pipelines are relatively independent from each other, wherein the pipelines are provided therein with electric control valves configured for controlling opening and closing of the pipelines, and the electric control valves are relatively independent from each other;
the mounting clamp is configured to fix a body of the bottle, and the mounting clamp is fixedly connected to the sliding table;
the bottle-in track is arranged on a side of the machine platform;
the bottle-out track is arranged on a side of the machine platform;
the bottle-grabbing manipulator is movable among the feeding station, the middle-ring pressing station, a discharge end of the bottle-in track, and a feeding end of the bottle-out track, and is configured to pick up the bottle the central processor is configured to receive external user information and generate corresponding product formula information; and
the controller is electrically connected to the central processor and receives the product formula information from the central processor; the controller is electrically connected to the electric control valves and is configured to control opening and closing of the electric control valves; and the controller is electrically connected to the sliding table and is configured to control a movement distance of the sliding table.

2. The customized perfume-filling equipment according to claim 1, further comprising a laser marking mechanism, wherein the laser marking mechanism is arranged at the feeding station, and is capable of being provided corresponding to the mounting clamp, wherein the laser marking mechanism is electrically connected to the central processor, and receives the product formula information from the central processor.

3. The customized perfume-filling equipment according to claim 1, further comprising a capping mechanism, a cap-grabbing manipulator, and a flexible cap placement tray, wherein the capping mechanism is arranged at the capping station the capping mechanism is configured to cap the bottle located on the mounting clamp, and the cap-grabbing manipulator is configured to place the flexible cap onto a top of the bottle.

4. The customized perfume-filling equipment according to claim 3, wherein the capping mechanism comprises a base a pressing shaft a rolling blade shaft and a rolling blade,
wherein the base is fixed to a surface of the machine platform;
the pressing shaft is pivotally arranged on the base, the pressing shaft is capable of being raised and lowered along an axial direction of the pressing shaft on the base, and a lower end of the pressing shaft is provided with an open pressing groove; the rolling blade shaft is mounted on the base and capable of being raised and lowered, and the rolling blade shaft is arranged parallel to the pressing shaft; and
one end of the rolling blade is provided with a blade edge, and the other end is rotatably connected to a lower end of the rolling blade shaft; when the rolling blade shaft descends, the blade edge swings toward an inner side of the pressing groove to press the flexible cap tightly, and when the rolling blade shaft raises, the blade edge swings outward to disengage from the flexible cap.

5. The customized perfume-filling equipment according to claim 4, wherein the capping mechanism further comprises a sliding rod, one end of the sliding rod is slidably mounted on the base, and the other end is rotatably connected to the rolling blade, and a connection position between the sliding rod and the rolling blade is located between the blade edge and a connection position between the rolling blade shaft and the rolling blade.

6. The customized perfume-filling equipment according to claim 4, wherein on a section along the axial direction of the pressing shaft, an inner side surface of the pressing groove is inclined toward outside from top to bottom.

7. The customized perfume-filling equipment according to claim 1, wherein the filling system comprises a raw liquid supply portion, a liquid mixing portion and a mixed liquid supply portion,
wherein the raw liquid supply portion is configured to provide liquids for mixing;
the liquid mixing portion comprises a dilution component, a pressure-stabilizing valve body, and a flow meter, wherein the dilution component is connected to the raw liquid supply portion, and is configured to receive a liquid from the raw liquid supply portion, and mix it to obtain a mixed liquid; the pressure-stabilizing valve body and the flow meter are arranged on a pipeline connecting the raw liquid supply portion to the dilution component; the pressure-stabilizing valve body is configured to control a flow rate of a liquid passing through the flow meter; and the flow meter is configured to measure a flow rate of a liquid passing through the pipeline; and
the mixed liquid supply portion comprises a first pump and a supply component, wherein the first pump is connected to the dilution component and the raw liquid supply portion, and is configured to transport the liquid from the raw liquid supply portion to the dilution component; the supply component is connected to the dilution component, and is configured to receive and store the mixed liquid from the dilution component; and the supply component contains a second pump and is connected to the pipeline, and the mixed liquid in the supply component is supplied into the pipeline through the second pump.

8. The customized perfume-filling equipment according to claim 7, wherein the filling system further comprises a control component, and the control component is electrically connected to the central processor, and is configured to receive the product formula information from the central processor, and the control component is electrically connected to the mixed liquid supply portion, and presets and controls a flow rate and a discharge time of a liquid in the mixed liquid supply portion based on the product formula information from the central processor.

9. The customized perfume-filling equipment according to claim 1, further comprising a middle-ring pressing mechanism, a middle-ring grabbing manipulator, and a middle-ring placement tray, wherein the middle-ring pressing mechanism is arranged at the middle-ring pressing station, the middle-ring pressing mechanism is configured to press a middle ring on the bottle located on the mounting clamp, and the middle-ring grabbing manipulator is configured to arrange the middle ring onto the bottle.

10. The customized perfume-filling equipment according to claim 9, wherein the middle-ring pressing mechanism comprises a frame, a clamping block, a pressing rotating wheel, and a clamping sleeve,
wherein the frame is fixedly mounted on the machine platform;
the clamping block is mounted on the frame in a horizontally movably manner, and the clamping block is provided with a clamping groove;
the pressing rotating wheel is pivotally mounted on the machine platform, and the pressing rotating wheel is movable along a horizontal plane on the machine platform reciprocating relative to the clamping block, to cooperate with the clamping block to form a pressing region;
the clamping sleeve is located above the pressing region, the clamping sleeve is mounted on the frame and capable of being raised and lowered, and the clamping sleeve is configured to be sleeved on the top of the bottle,
wherein the clamping block is connected with a first cylinder, wherein the first cylinder is configured to drive the clamping block to reciprocate relative to the pressing rotating wheel; a slider is arranged on the frame wherein the pressing rotating wheel is pivotally mounted on an upper surface of the slider, the slider is connected with a second cylinder, and the second cylinder is configured to drive the slider to reciprocate relative to the clamping block; and the clamping sleeve is connected with a third cylinder, the third cylinder is configured to drive the clamping sleeve to be raised and lowered, and the first cylinder, the second cylinder, and the third cylinder are all fixedly connected to the frame.
